(19) United States
(12) Patent Application Publication
(10) Pub. No.: US 2022/0319134 A1
(43) Pub. Date: Oct. 6, 2022

(54) Contextual Message Delivery in Artificial Reality

(71) Applicant: Meta Platforms Technologies, LLC, Menlo Park, CA (US)

(72) Inventors: Annika RODRIGUES, Lynnwood, WA (US); Camila Cortes DE ALMEIDA E DE VINCENZO, Seattle, WA (US); Jonathan Michael PROTO, San Francisco, CA (US); Jenny KAM, Seattle, WA (US)

(21) Appl. No.: 17/845,645

(22) Filed: Jun. 21, 2022

Related U.S. Application Data
(60) Provisional application No. 63/322,447, filed on Mar. 22, 2022.
(60) Provisional application No. 63/293,326, filed on Dec. 23, 2021.
(60) Provisional application No. 63/276,856, filed on Nov. 8, 2021.
(60) Provisional application No. 63/270,234, filed on Oct. 21, 2021.

(51) Int. Cl. G06T 19/00; G06F 3/01

(52) U.S. Cl. CPC G06T 19/006; G06F 3/017

(57) ABSTRACT

An artificial reality communications and sharing system can deliver messages when a specified recipient context is detected; can display artificial reality gesture effects in response to particular gesture triggers tied to those XR gesture effects; can define actions of an artificial reality content sharing system for sharing content to user-selectable destinations; and can automatically update a user's status in an artificial reality social-networking setting.

### CROSS REFERENCE TO RELATED APPLICATIONS

This application claims priority to U.S. Provisional Application Nos. 63/270,234 filed Oct. 21, 2021, titled “Contextual Message Delivery in Artificial Reality,” 63/293,326 filed Dec. 23, 2021, titled “Gesture Triggered Artificial Reality Messaging Effects,” 63/276,856 filed Nov. 8, 2021, titled “Artificial Reality Content Sharing Model,” and 63/322,447 filed Mar. 22, 2022, titled “Automatically Updating Status.” Each patent application listed above is incorporated herein by reference in their entireties.

### BACKGROUND

People are in general social creatures who bond with one another through their enjoyment of shared activities. This social sharing has an importance in addition to the importance of the activity itself as when friends work together to accomplish a goal even when one of them could more efficiently accomplish the goal by pursuing it alone. When friends are physically separated and cannot actually engage in a shared activity, they can still reap some of the joys of social sharing by pursuing the same activities at the same time, physically separated but temporally parallel, or by sharing with their friends timely updates of their pursuits.

In an artificial reality environment, some of the objects that a user can see and interact with are virtual objects, which can be representations of objects generated by a computer system. Devices such as head-mounted displays (e.g., smart glasses, VR/AR headsets), mobile devices (e.g., smartphones, tablets), projection systems, “cave” systems, or other computing systems can present an artificial reality environment to the user, who can interact with virtual objects in the environment using body gestures and/or controllers. Some of the objects that a user can also interact with are real (real-world) objects, which exist independently of the computer system controlling the artificial reality environment. For example, a user can select a real object and add a virtual overlay to change the way the object appears in the environment. While there are some messaging systems provided by artificial reality devices, such messaging tends to be presented as standalone virtual objects (e.g., a 2D panel in a 3D space) that a user can bring up or pin to a location, without regard for the recipient's context or actions in delivering such a message or how the recipient may receive such a message. Further, while there are some messaging systems that provide content item sharing from artificial reality devices, such content item sharing tends to be presented by the application controlling a virtual object, making content sharing inconsistent across applications, and thus difficult and frustrating to use.

### SUMMARY

Aspects of the present disclosure are directed to an artificial reality (XR) messaging system that delivers messages when a specified recipient context is detected. When a message sender creates a message, she can specify a context expression with delivery conditions. The XR messaging system can monitor the recipient user's context conditions to determine when the context expression is satisfied (e.g., evaluates to true), and in response, deliver the message. In some cases, the message can also be delivered when default delivery conditions occur, even if the context expression is not satisfied, such as if a threshold amount of time having passed. A context expression can join, through logical operators, a variety of context conditions such as physical conditions (e.g., where the user is, what's going on around the user, the user's physical movements, etc.); social conditions (e.g., who the user is interacting with, the user's background/history; the user's specified interests, etc.); temporal conditions (e.g., date/time of day, events, user's availability/status); or expressed conditions (e.g., user input specifying a condition such as messaging content, emoticons, tags, etc.) In some cases, the message sender may also specify how the message is delivered, such as being attached to a particular object or object type, adding a delivery animation, etc.

Additional aspects of the present disclosure are directed to an artificial reality system that displays artificial reality gesture effects in response to particular gesture triggers tied to those XR gesture effects. The XR gesture effect can be provided to the artificial reality system in various ways such as through a message from a sending user, by a user of the artificial reality system adding the XR effect to her environment, by an application executing on the artificial reality device creating the XR gesture effect, etc. When an XR gesture effect with a gesture trigger is available, the artificial reality system can provide a notification to the user, instructing the user to make the gesture that will trigger the XR gesture effect. The artificial reality system can monitor body positions of the user and when a particular body position (e.g., hand posture) matches the gesture for the XR gesture effect, the XR gesture effect can be activated. This can include showing a 2D or 3D model, which can be animated. In various cases, XR gesture effects can be activated to display in relation to the gesture (e.g., attached to it), as attached to a surface in the artificial reality environment, or as a head or body locked element.

Further aspects of the present disclosure are directed to a model defining actions of an artificial reality content sharing system for sharing content to user-selectable destinations. The XR content sharing system can allow an artificial reality device user to share XR content to destinations such as another user, an application, or a specified place. The artificial reality device user can initiate the sharing process by taking several actions including selecting a content item and then selecting a sharing user interface (UI) element, dragging and dropping the content item onto an element in her artificial reality environment corresponding to a destination, or providing a sharing voice command. In some cases, how the sharing was initiated can specify a destination while in other cases the XR content sharing system can provide further flows for the artificial reality device user to select a destination or other sharing parameters. When a sharing destination is another user the content item can be provided to the other user in various communication channels. When a sharing destination is an application, the application can be configured to take a corresponding action. When a sharing destination is a specified place, the content can be delivered to that place (which may exist in a single physical location, multiple physical locations, and/or other virtual locations such as menus, Uls, etc.)

Yet further aspects of the present disclosure are directed to automatically updating a user's status in an artificial reality social-networking setting. In some cases, the user can specify that a certain status be set when the user is within a threshold distance of a set location (e.g., in the kitchen) for a threshold amount of time. In some cases, the XR system can monitor the user's location, movements, interactions with virtual objects and with others, and the like and determines that the user has begun to engage in a particular activity. The XR system then automatically creates a status (e.g., “preparing a meal”) and posts it to the user's social network notifying his friends that he is now engaged in the determined activity. For privacy, safety, and other reasons, the user or XR system can specify that some activities generate either a generic “busy” status or no status at all.

### BRIEF DESCRIPTION OF THE DRAWINGS

FIG. 1 is a first example of a contextually delivered message for a user action context.

FIG. 2 is a second example of a contextually delivered message for a first location context.

FIG. 3 is a third example of a contextually delivered message for a second location context.

FIG. 4 is a fourth example of a contextually delivered message for a location and co-location context.

FIG. 5 is a flow diagram illustrating a process used in some implementations for timing message delivery based on a contextual expression.

FIG. 6 is an example of a notification of an XR gesture effect pinned to a particular location in an artificial reality environment.

FIG. 7 is an example of a notification of an XR gesture effect sent in a messaging thread.

FIG. 8 is an example of an XR gesture effect displayed in response to, and in relation to, a triggering gesture.

FIG. 9 is a flow diagram illustrating a process used in some implementations for displaying an XR gesture effect in response to a particular gesture trigger.

FIG. 10 is an example of a user interface for selecting options in relation to a selected content item.

FIG. 11 is an example of a user interface for selecting a sharing destination for a selected content item.

FIG. 12 is an example of a user interface for optionally adding a message to accompany a shared content item when sharing to a person or place.

FIG. 13 is a flow diagram illustrating a process used in some implementations for providing interfaces and interactions modalities for sharing a content item to a user-selected destination.

FIG. 14A is a conceptual drawing illustrating a user engaged in a work call.

FIG. 14B is a conceptual drawing illustrating a user walking a real dog while engaged in an XR environment.

FIG. 14C is a conceptual drawing illustrating a virtual object being placed in a kitchen and associated with a specific status of “Cooking.”

FIG. 14D is a conceptual drawing illustrating a user approaching the previously set kitchen virtual object.

FIG. 14E is a conceptual drawing illustrating the status “Cooking” automatically generated when the user is in proximity of the kitchen virtual object of FIG. 14C.

FIG. 14F is a conceptual drawing illustrating the user leaving the proximity of the kitchen virtual object of FIG. 14C.

FIG. 15 is a flow diagram illustrating a process used in some implementations of the present technology for automatically updating a user's status.

FIG. 16 is a block diagram illustrating an overview of devices on which some implementations of the present technology can operate.

FIG. 17 is a block diagram illustrating an overview of an environment in which some implementations of the present technology can operate.

### DESCRIPTION

Aspects of the present disclosure are directed to an artificial reality (XR) messaging system that delivers messages when a specified recipient context is detected. Artificial reality devices can understand an array of contextual conditions of a user, yet existing messaging systems don't account for these, ignoring them as controls for how, where, and when messages are delivered. The XR messaging system described herein allows messages sent to a recipient to be delivered conditionally based on sender-selected context conditions (e.g., combinations of location, activity, surroundings, time/date, etc.)

When a message sender creates a message, she can specify input that creates a delivery context expression. The context expression can specify occurrence of one or more context conditions (with comparators such as NOT, GREATER, LESS, EQUALS, etc.), which can be compounded for multiple context conditions combined with one or more logical operators (e.g., AND, OR, XOR, etc.) The context conditions can be any condition identifiable by an artificial reality device or through a connected system such as physical conditions (e.g., where the user is, what's going on around the user, the user's physical movements, etc.); social conditions (e.g., who the user is interacting with, the user's background/history; the user's specified interests, etc.); temporal conditions (e.g., date/time of day, events, user's availability/status); or expressed conditions (e.g., user input specifying a condition such as messaging content, emoticons, tags, etc.) In some cases, the message sender can also specify additional delivery options for how the messages is shown to the recipient (e.g., head or body locked, world locked to specified object or surface type; size, orientation, position; corresponding delivery animation or other content, etc.)

When a message is specified with a context expression, the context conditions in the context expression can be registered to be monitored for the message recipient. Through these registrations, the XR messaging system can receive notifications of when the context conditions occur/change and, in response, can evaluate the corresponding context expression. If the context expression is satisfied (e.g., evaluates to true), the XR messaging system can deliver the message. This can include delivering the message according to the delivery options, if specified, or, if not specified, delivering through default delivery options. In some cases, the message can also be delivered when default delivery conditions occur, even if the context expression is not satisfied, such as if a threshold amount of time has passed.

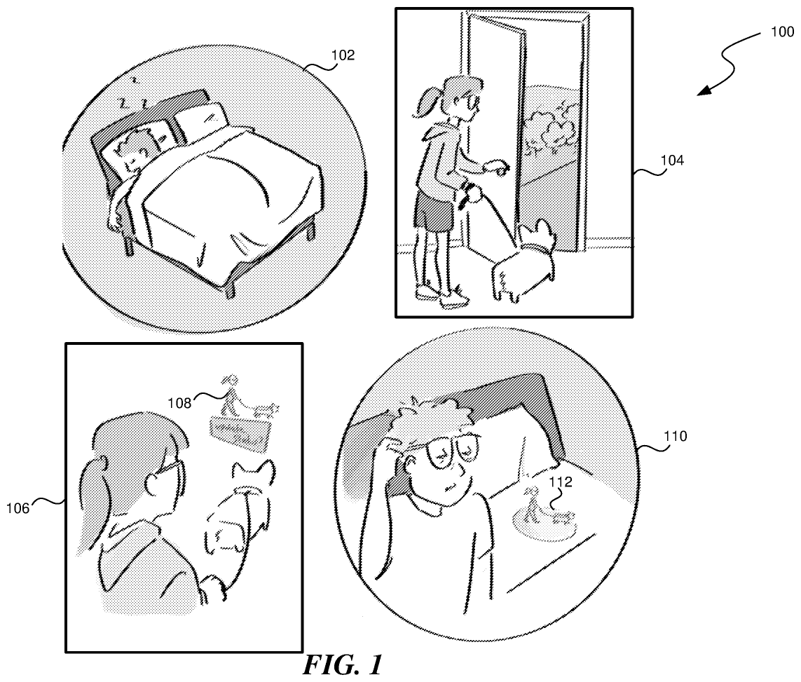

FIG. 1 is a first example 100 of a contextually delivered message for a user action context. In example 100, a couple uses the XR messaging system to update each other on their status. At 102, a first user of the couple is still in bed while at 104 a second user of the couple is taking their dog for a walk. At 106, the second user creates a message 108 saying she is walking the dog, with a context expression defining that delivery of the message is to occur when the first user has a contextual condition of a getting out of bed action. At 110, the XR messaging system identifies that the first user is getting out of bed and thus the contextual expression evaluates to true, and in response, delivers the message at 112.

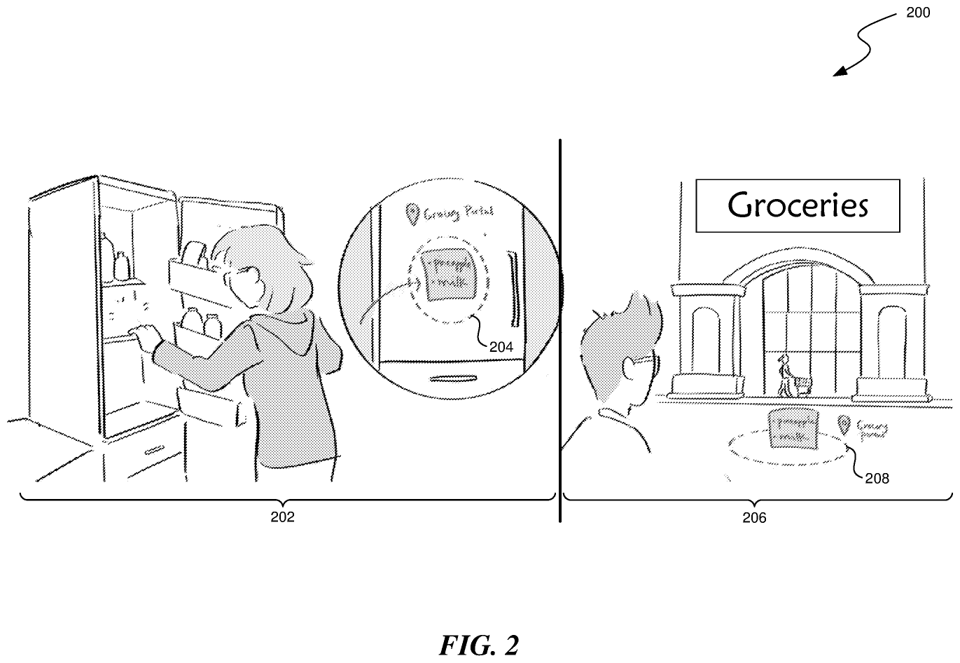

FIG. 2 is a second example 200 of a contextually delivered message for a first location context. In example 200, once again a couple uses the XR messaging system, this time to provide reminders to each other when they will be most relevant. At 202, a first user of the couple is viewing the contents of their refrigerator and decides that several items are needed. She has setup a portal 204 which is preconfigured with a context expression for delivering messages, added to the portal, when a second user is at a particular location type (a grocery store). The first use has added a message for pineapple and milk to the portal. At 206, when the second user has a condition context causing the context expression to evaluate to true (i.e., he is at a location with a grocery store type) the XR messaging system delivers the message 208 to him.

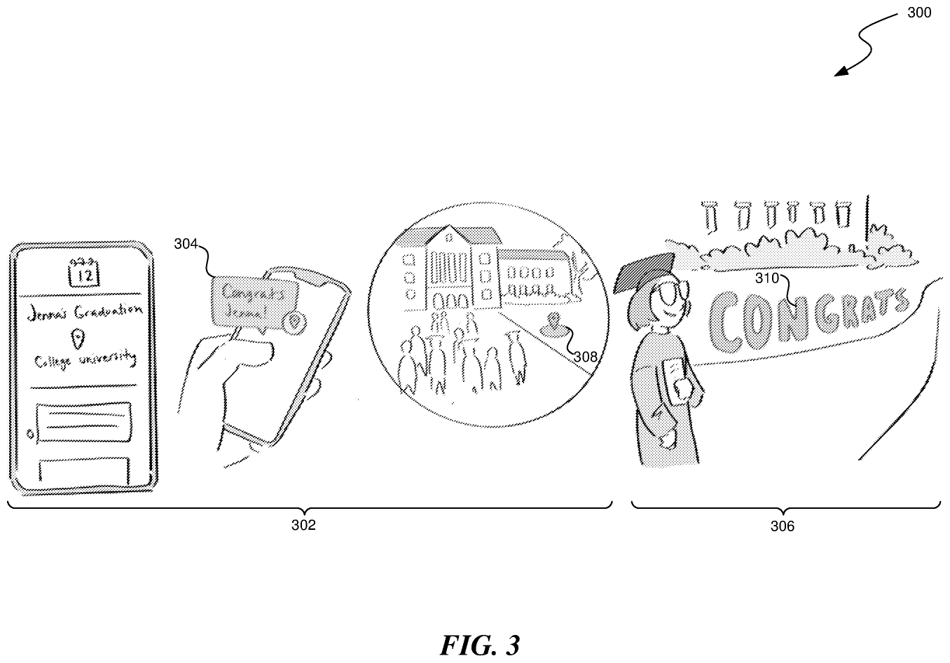

FIG. 3 is a third example 300 of a contextually delivered message for a second location context. In example 300, at 302, a message sender is providing a “Congrats” message 304 with a context expression specifying the message is to be delivered when the recipient is at a specified location 308 for a graduation ceremony during the time of the ceremony. When the recipient is at the location 308 during the specified time, the contextual expression evaluates to true, causing the XR messaging system to display the message 310.

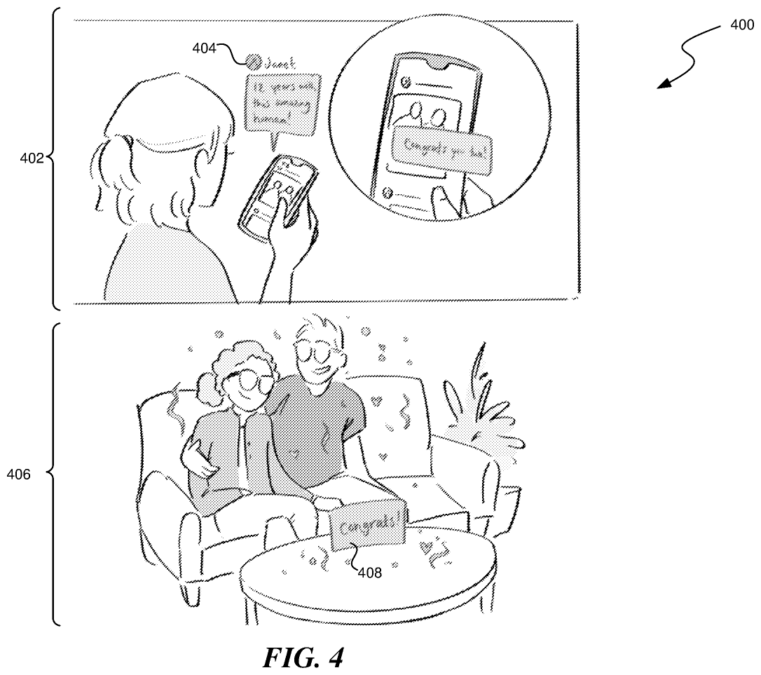

FIG. 4 is a fourth example 400 of a contextually delivered message for a location and co-location context. In example 400, at 402, a user is sending an anniversary message 404 to a couple. The user specifies that the message should be delivered to both people of the couple, when the couple is together and are at home. This causes the XR messaging system to create a context expression for the context condition that locations for the people of the couple are within a threshold distance of one another and that those locations match a home area defined for the couple. At 406, this context expression evaluates to true, causing the XR messaging system to display message 408.

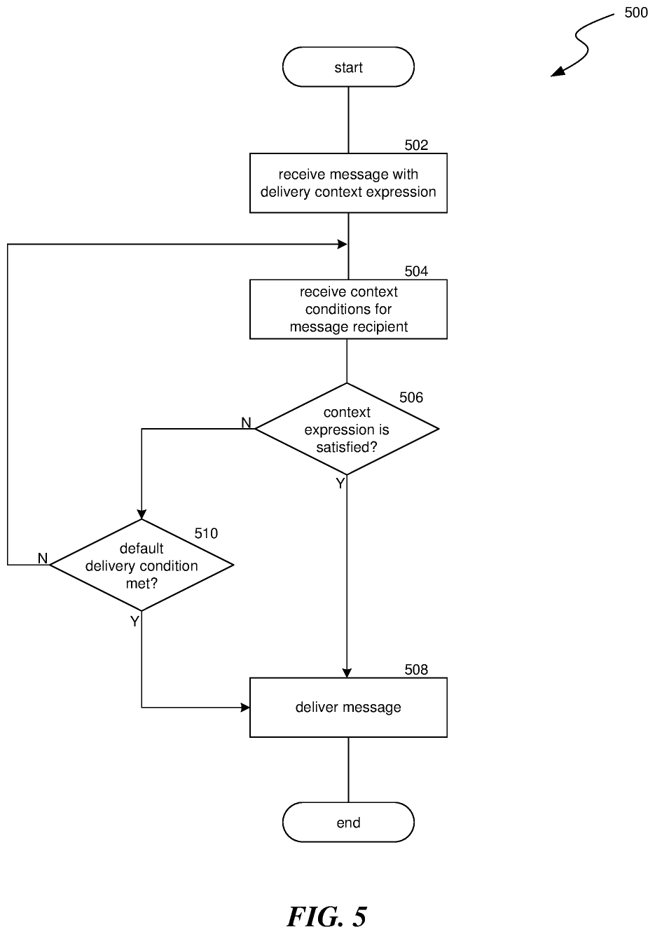

FIG. 5 is a flow diagram illustrating a process 500 used in some implementations for timing message delivery based on a contextual expression. Process 500 can be performed A) on an artificial reality device that receives messages for users of the artificial reality device and delivers them in a particular context or B) on a server system that receives messages and context conditions for various users and delivers the messages to the recipient devices when the context conditions cause context expressions corresponding to the messages to be satisfied. Process 500 can be performed as a service on the executing device, to be available for a controlling application (e.g., operating system or messaging system) to execute in response to receipt of a message with a context expression.

At block 502, process 500 can receive a message with a context expression specifying delivery conditions. The context expression can be an expression built by a sending user or built by the XR messaging system in response to selections by the sending user (e.g., through a composer widget of a messaging application). The context expression can specify any context condition that can be determined for a recipient along with a comparison operator (e.g., =, >, <, >=, <=, NOT, etc.) allowing the context condition to be a statement evaluated into a true or false result. The context expression can also specify compound conditions for multiple context condition statements with logical operators (e.g., AND, OR, XOR, etc.) allowing the multiple context condition statements to also evaluate to an overall true or false result. In some cases, instead of building a custom context expression, a message sender can select a pre-defined delivery context mapped to an existing context expression. For example, the sending user may select a “sensitive” pre-defined delivery context, which is mapped to a context expression for the recipient being in an area identified in a private category and with the recipient being in a sitting down posture.

Context conditions that can be used in a context expression can be conditions determined by the artificial reality device of the recipient (e.g., via gathered data through sensors, cameras, etc. and resolved into context conditions such as through the application of algorithms and machine learning models) and/or with data provided by external systems (e.g., mapping systems, weather services, social media platforms, messaging systems, search services, etc.) Examples of context conditions that can be used in context expressions include physical context conditions, social context conditions, temporal context conditions, and expressed context conditions.

Physical context conditions are identified spatial information about the user and her surroundings. Examples of physical context conditions include geo-location status (e.g., latitude, longitude, elevation, relation to landmarks or defined areas, area types such as at home, outside, at a grocery, at the Eifel Tower, etc.), inferences from body, head, and eye tracking (e.g., gestures made, facial expression, speed of movement, conversation state, posture—such as sitting, standing, walking, driving—gaze direction or target, etc.), and inferences from surroundings and atmosphere (e.g., location state such as crowded bar, private room, place of worship, fancy restaurant, types or identities of nearby objects, lighting conditions, weather or temperature conditions, etc.)

Social context conditions specify features of the user's background (e.g., interests, relationships, interactions, etc.) and who the user is near and their backgrounds. Examples of social context conditions include interpersonal information (e.g., background, beliefs, mood, emotion, feelings, etc.), intrapersonal information (e.g., groups and group types, audience information, location check-ins, etc.), and cultural information (e.g., group or work culture, geographic culture, religious culture, etc.)

Temporal context conditions specify features depending on the date and/or time. Examples of temporal context conditions include time events (e.g., exact time or date, time zone, time slot—such as morning, afternoon, evening, dinner time, recess, etc.), planned events (e.g., a particular concert, work meeting, social event, class, commuting, sleeping, etc.), and life events (e.g., anniversary, birthday, baby being born, etc.)

Expressed context conditions specify features of the user based on the user's communications. Examples of expressed context conditions include features of the user's inputs such as emoticons, attached photos or videos, gifs use, phrases used, captions provided, tags associated with content, punctuation, etc.

In some cases, a message sender can also select options for delivery of the message defining how the message will initially be shown to the recipient. For example, the delivery options can state how the message is to be locked in the artificial reality environment (e.g., head locked, body locked, or world locked); to which specified object, surface, object type, or surface type the message will be attached; a size, orientation, position for the message; corresponding delivery animation or other content to be shown with message delivery, etc.

In some implementations, until the message is delivered to the recipient, the undelivered message can show up for the sender in a message thread between the sender and the recipient. This can indicate whether the message has been delivered and can provide options to cancel delivery of the message or edit it (including editing the content and/or delivery context expression).

At block 504, process 500 can receive context conditions for the message recipient. As discussed above these can be any identifiable feature of the recipient, gathered through the recipient's artificial reality device, other devices in the area, or external systems. In some implementations, data gathered from these systems can be analyzed with algorithms and/or machine learning models to identify further inference context conditions.

At block 506, process 500 can determine whether, based on the received context conditions, the context expression is satisfied. Process 500 can accomplish this by plugging each of the determined context conditions into the context expression, using the comparison operators to determine true/false values for each context condition statement, and then using the logical operators to determine an overall true/false value for the context expression. If the context expression evaluates to true, process 500 can continue to block 508. If the context expression evaluates to false, process 500 can continue to block 510.

At block 510, process 500 can determine whether a default delivery condition has been met. For example, the user or XR messaging system can define conditions that will cause delivery of the message even when the context expression has not been satisfied, such as a time limit, a distance from a location, delivery of the message to other recipients, etc. If the default delivery condition is met, process 500 can continue to block 508. If the default delivery condition is not met, process 500 can return to block 504.

At block 508, process 500 can deliver the message to the specified recipient(s). If any delivery options were specified, the delivery can be performed according to these delivery options (e.g., attempting to find a specified object or object type to attach to, setting message size and orientation, etc.) if the artificial reality environment has the features necessary to satisfy the delivery options. If delivery options are not set or cannot be satisfied, then by default the message can be delivered through a head locked or body locked notification. When the recipient opens the message notification, the XR messaging system can find an open surface to which the message can be attached. In some implementations, upon delivery, the message sender is notified that the delivery occurred. A representation of the message may also be shown in a messaging thread that exists between the sender and recipient. Process 500 can then end.

An artificial reality system can display artificial reality (XR) gesture effects in response to particular gesture triggers tied to those XR gesture effects. XR gesture effects can be defined by a creator that supplies the effect, such as a 2D or 3D model, which may be animated, and that pairs the effect with a gesture trigger that an artificial reality device can recognize. For example, an artificial reality device may have one or more machine learning models trained to take sequences of image representations (depicting at least part of a user) or other body posture data (e.g., from wearable devices) and provide results specifying whether the user is making any of a set of gestures the models are trained to recognize. The XR gesture effect creator can pair the provided effect with any of the set of gestures the machine learning models are trained to recognize. A message sender, artificial reality device user, or application can then select such a XR gesture effect to include in a message or otherwise place in the artificial reality environment.

A user of the artificial reality device can receive notifications of available XR gesture effects, e.g., when a message is received with such an XR gesture effect attached or when the XR gesture effect has been pinned into an area the user has entered. The notification can include an indication of the gesture the user needs to make to trigger the XR gesture effect. The artificial reality device can monitor the artificial reality device user's movements and poses (e.g., of the user's hands, limbs, head, etc.), applying the machine learning models to images or other inputs, to determine when the user performs the triggering pose. In some cases, the XR gesture effect is only triggered when other criteria are also met, such as the user looking at the message thread or location where the XR gesture effect is pinned, the gesture being in the user's field of view, etc. Once the XR gesture effect is activated, it can display according to its own display rules or default display rules. For example, the XR gesture effect can, by default, display in relation to the triggering gesture, but the XR gesture effect creator can specify other display rules such as displaying the XR gesture effect on the closest flat or vertical surface, as a head-locked virtual object, etc.

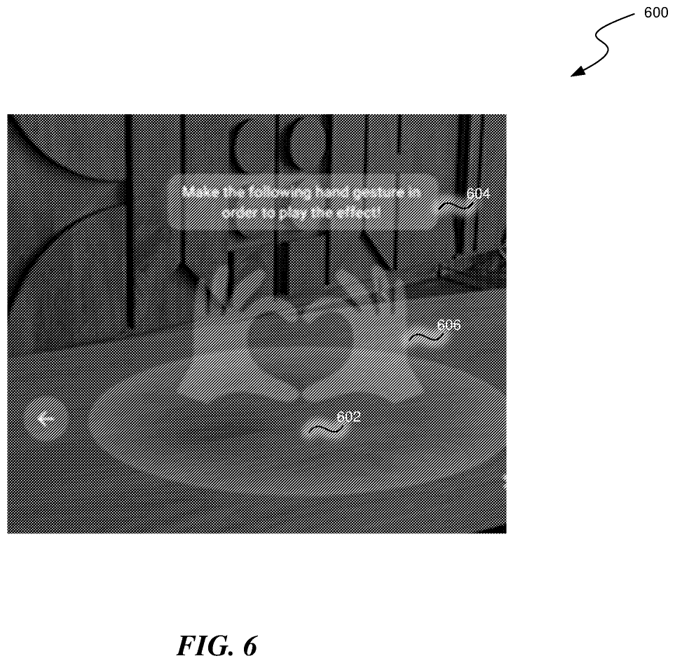

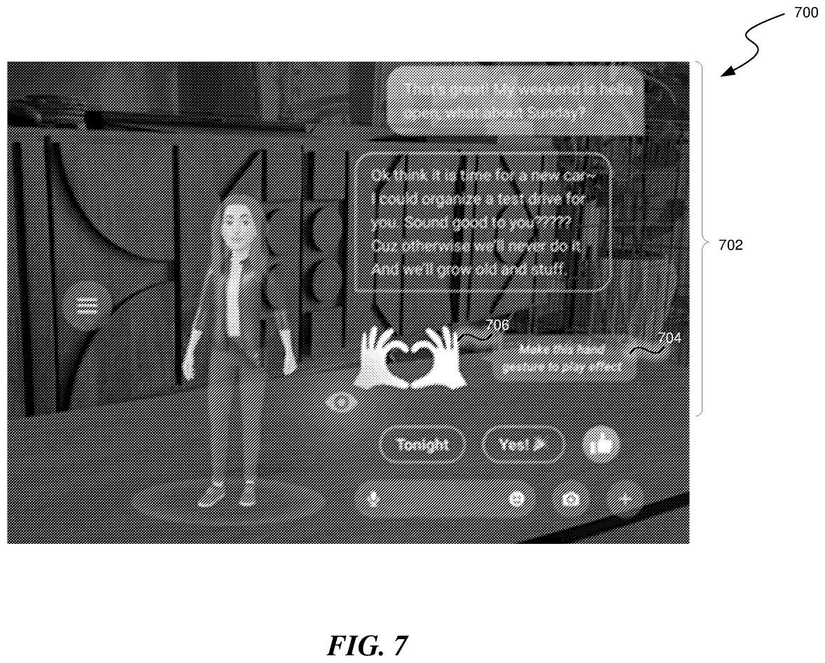

FIGS. 6 and 7 are examples of XR gesture effect notifications. FIG. 6 is an example 600 of a notification of an XR gesture effect pinned to a particular location in an artificial reality environment. In example 600, an XR gesture effect has been pinned at location 602. When a user of an artificial reality device is looking at location 602, a notification 604 of the XR gesture effect is displayed along with an indication 606 of the gesture the user needs to make to activate the XR gesture effect. FIG. 7 is an example 700 of a notification of an XR gesture effect sent in a messaging thread. In example 700, an XR gesture effect has been sent in a message thread 702. The message thread 702 includes a notification 704 of the XR gesture effect, along with an indication 706 of the gesture the user needs to make to activate the XR gesture effect.

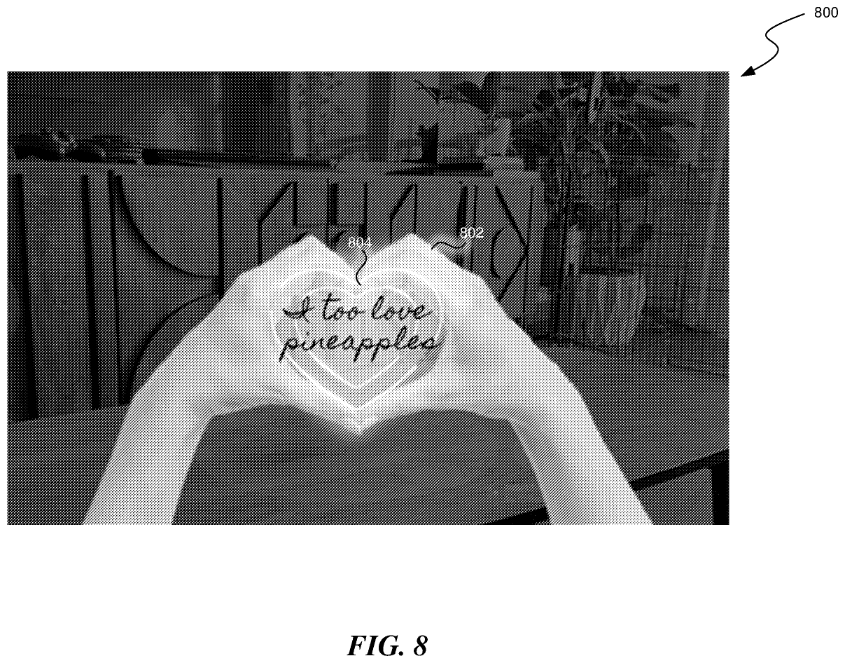

FIG. 8 is an example 800 of an XR gesture effect displayed in response to, and in relation to, a triggering gesture. In example 800, an XR gesture effect 804 is triggered by a user making a “heart” gesture with her hands. The user's hands have made the heart gesture 802, thus causing the artificial reality system to display the XR gesture effect 804. In example 800, the XR gesture effect 804 is configured to display itself in the middle of the heart gesture.

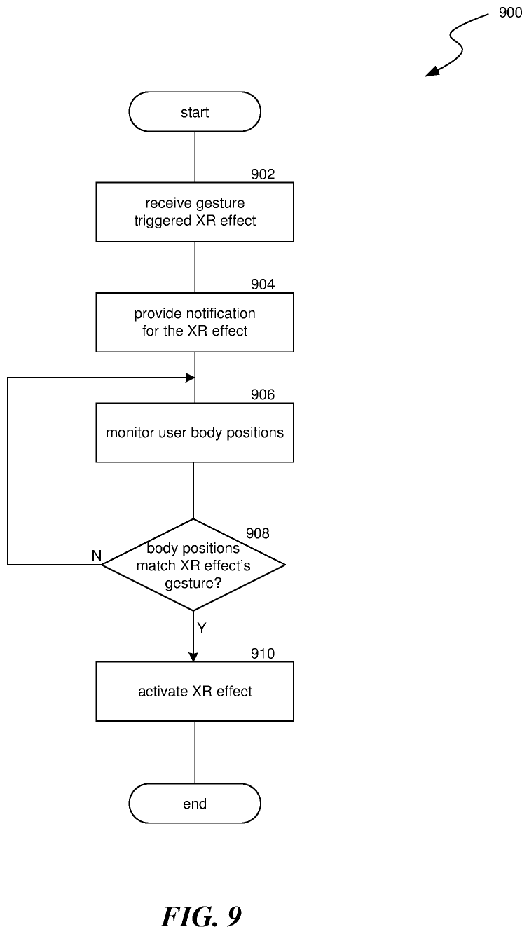

FIG. 9 is a flow diagram illustrating a process 900 used in some implementations for displaying an XR gesture effect in response to a particular gesture trigger. Process 900 can be executed on an artificial reality device, e.g., by a messaging application, an application in control of an artificial reality environment (e.g., a “shell” application), or by any other application able to create content in the artificial reality environment.

At block 902, process 900 can receive a gesture triggered XR effect (an “XR gesture effect”). In some implementations, the XR gesture effect can be received as part of a message, e.g., in a message thread or in a messaging portal pinned to a particular physical location. In other implementations, the XR gesture effect can be pinned to a location by a user of the artificial reality device or can be provided by an application executing on the artificial reality device. The XR gesture effect can be generated by a creator that supplies an effect and matches the effect with a gesture that an artificial reality device can recognize (as discussed below in relation to block 906). The creator can then provide the XR gesture effect himself to send in a message, pin in his artificial reality environment, or for use by an application. The creator can also share the XR gesture effect, allowing other users or applications to select it for inclusion in a message or artificial reality environment.

At block 904, process 900 can provide a notification for the gesture triggered XR gesture effect. In various implementations, the notification can be included as a part of a message thread (an example of which is in FIG. 7) or the notification can be displayed in a notification area (e.g., a portion of the user's field of view), or in an area where the XR gesture effect was pinned (an example of which is in FIG. 6).

At block 906, process 900 can monitor user body positions. In various implementations, monitoring body positions can be based on information from one or more of cameras, LIDAR sensors, wearable device sensors, IR sensors, inertial motion unit (IMU) sensors, etc. For example, cameras on an artificial reality device can capture images of a user's hands to determine the hands' poses. As another example, a wearable device, such as a digital wristband, can include an IMU sensor and an electro sensor which can be used in combination to determine the motion and pose of the user's hands. The body position monitoring can monitor user body positions for particular body parts (e.g., hands, arms and legs, head) or for the body as a whole (e.g., mapping known body part positions to a kinematic model).

At block 908, process 900 can determine whether the monitored user body positions match the gesture for the XR gesture effect. In some implementations, this can include providing the monitored body position data, from block 906, to one or more machine learning models trained to determine whether the user is making one or more defined gestures. In some implementations, gestures can include motions, in which case block 906 can further include providing a sequence of the body position data, from block 906, to the one or more machine learning models. The one or more machine learning modes can provide results indicating which defined gesture(s) the user is making. Process 900 can determine if any of these gestures match the gesture for the XR gesture effect. In some implementations, process 900 can also perform other checks to trigger the XR gesture effect, such as determining one or more of: whether the user is concurrently looking at a location where the XR gesture effect is pinned or at a message thread in which the XR gesture effect was sent, whether the gesture being made is in the user's field of view, whether the notification of the XR gesture effect is in view in the message thread, etc. If the monitored user body positions match the gesture for the XR gesture effect (and any other triggering criteria is met), process 900 can continue to block 910; otherwise process 900 can return to block 906.

At block 910, process 900 can activate the XR gesture effect. Activating the XR gesture effect can include displaying it in the artificial reality environment and, where it is animated, beginning the animation. In various implementations, the XR gesture effect can be displayed, depending on how the XR gesture effect creator or sender setup the XR gesture effect or its default rules, in relation to where the user made the triggering gesture, in relation to a particular object, object type, or surface type, or in relation to the user (e.g., as a body-locked or head-locked virtual object). After activating the XR gesture effect, process 900 can end.

An artificial reality (XR) content sharing system can provide interfaces and interactions modalities for sharing a content item to a user-selected destination. The XR content sharing system can accomplish this by defining a flow that accounts for various ways an artificial reality device user may initiate sharing a content item and what additional information is needed to complete the sharing for each initiation method.

In a first selection method provided by the flow, the artificial reality device user can select a content item and initiate the sharing of the content item by selecting a sharing control on a user interface (UI) that is activated by the content item selection. Next the XR content sharing system can provide options for selecting a destination from among a set of people, places, or applications. The sets of people, places, or applications can be based on user selected favorites, entities the user interacts with most often, how close the user is to the other entity on a social graph, etc.

In a second selection method provided by the flow, the artificial reality device user can select a content item and drop it onto an object (real or virtual) associated with a person, place, or application destination. Examples of such objects include avatars representing other users that exist in the artificial reality device user's environment; an icon or object from an application; or a location, object, menu item, or other representation of a place. Again, the user can signal this action was to share the content item to the indicated destination by selecting a sharing control on a user interface (UI) that is activated by dropping the content item onto the other object.

In a third selection method provided by the flow a user can provide a sharing voice command specifying a specific person, place, or application. In some implementations, the voice command can also specify a content item to share or the voice command can implicitly be to share a previous selected content item (e.g., selected with a user's gesture).

When a sharing destination is another user the content item can be provided to the other user in various communication channels such as by posting a version of the content item to a social media feed of the other user, as a direct message to the other user, as an artificial reality environment notification provided to the other user, etc. When a sharing destination is an application, the application can be configured to take a corresponding action, such as to create a social media post, combine the content item with another item, execute a function with the content item as a parameter, etc. In some cases, the action of the application can be based on a type of the shared content item, so different types of content items can trigger different actions. When a sharing destination is a specified place, the content item can be delivered to that place, where a “place” can be a collection defined as attached to one or more physical locations and/or virtual locations such as menus, Uls, etc.

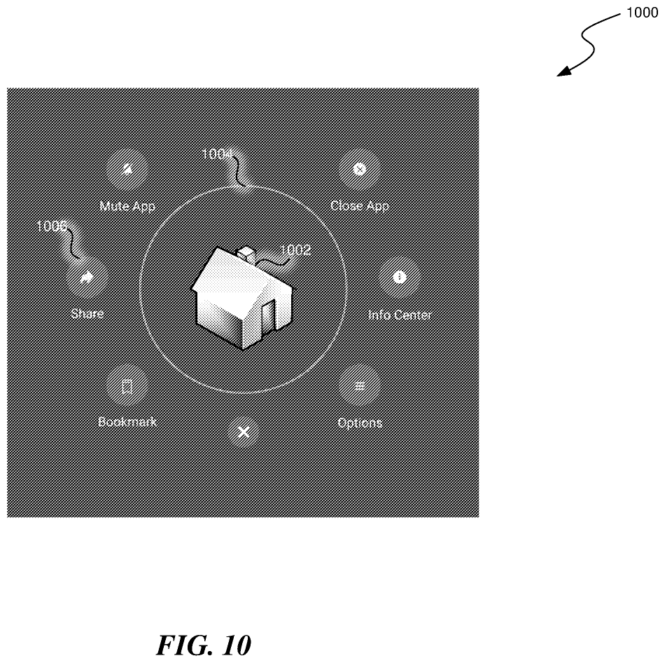

FIG. 10 is an example 1000 of a user interface for selecting options in relation to a selected content item. In example 1000, a user has selected a content item 1002, which caused the XR content sharing system to bring up circular UI 1004 with a variety of options. One of these options is the share UI 1006, which a user can select to initiate sharing of the content item 1002. In some cases, the UI 1004 is the UI used to present options as discussed below in relation to blocks 1310 and 1312.

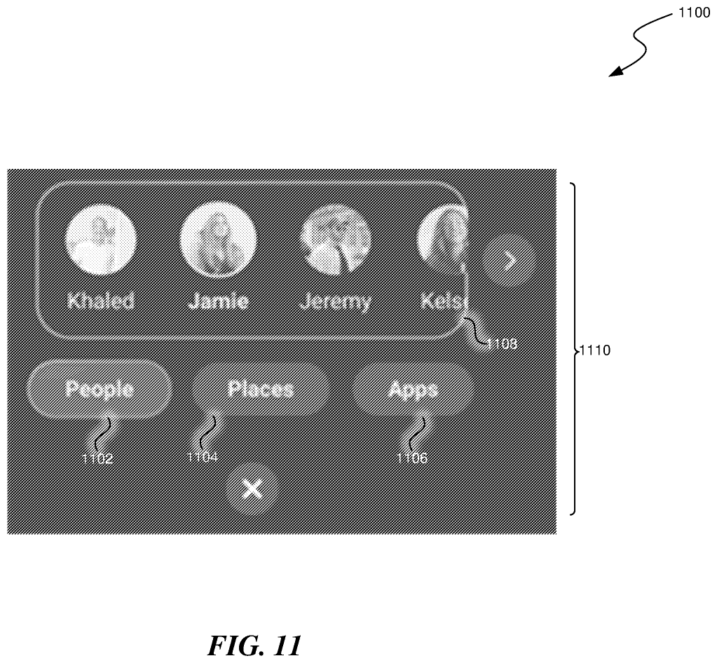

FIG. 11 is an example 1100 of a user interface for selecting a sharing destination for a selected content item. In example 1100, a user has selected a content item to share and selected a sharing control (such as UI 1006 of FIG. 10) and the XR content sharing system has brought up UI 1110 for the user to select a destination for the sharing action. In example 1100, the UI 1110 has three categories of destinations: people, places, and applications. The user can select UI 1102 to select the people category, UI 1104 to select the places category, or UI 1106 to select the applications category. Upon selection of one of Uls 1102, 1104, or 1106, the XR content sharing system can populate the specific destination selection section 1108 with entities from the selected category. The entities that populate into section 1108 can be the people, places, or applications the user has selected as favorites, entities the user interacts with most often, the entities the user is closest to according to a social graph, etc. In some cases, the UI 1110 is the UI used to identify a sharing destination as discussed below in relation to block 1314.

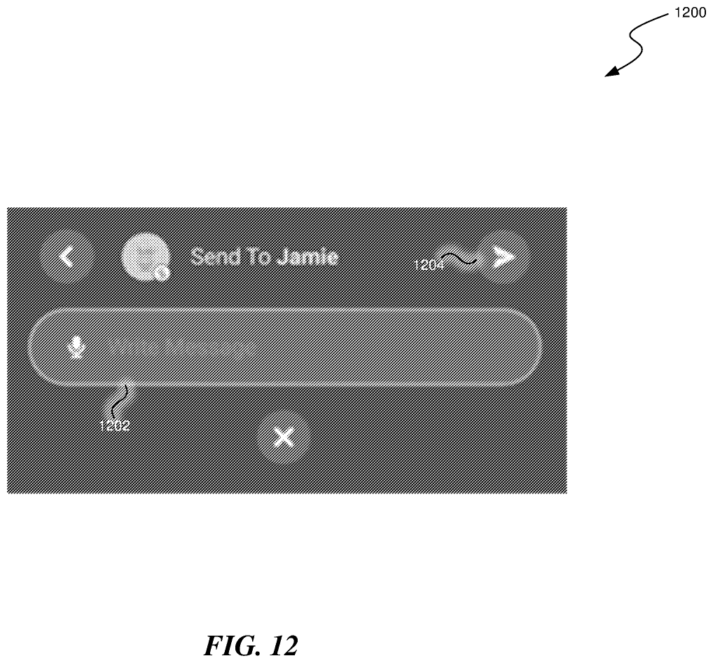

FIG. 12 is an example 1200 of a user interface for optionally adding a message to accompany a shared content item when sharing to a person or place. In example 1200, a user has initiated sharing of a content item to a person or a place. With the content item, the XR content sharing system can provide a user-supplied message, which the user can enter into message UI 1202 and then send the message with the content item by activating UI 1204.

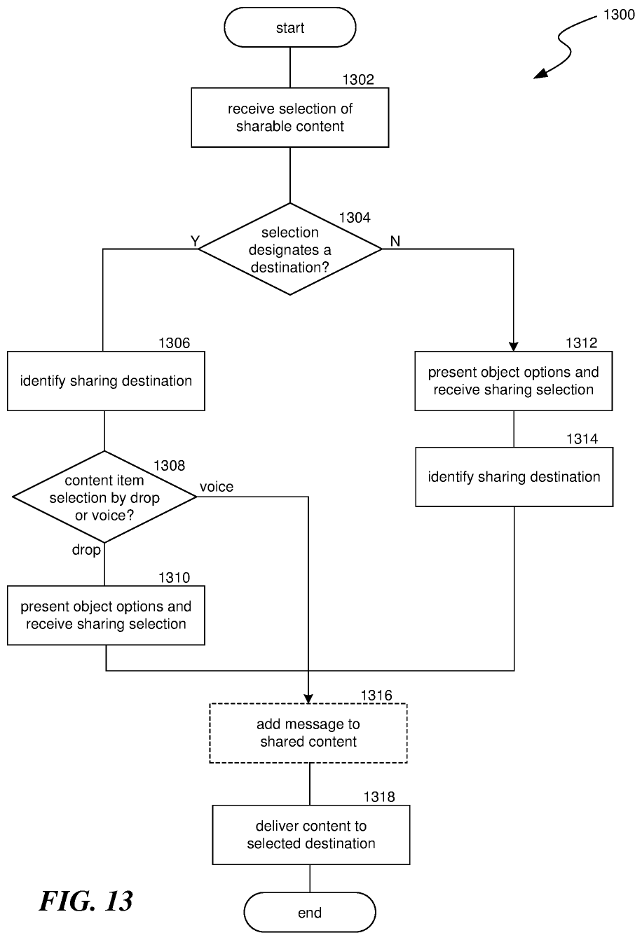

FIG. 13 is a flow diagram illustrating a process 1300 used in some implementations for providing interfaces and interactions modalities for sharing a content item to a user-selected destination.

At block 1302, process 1300 can receive, in an artificial reality environment, a selection of a sharable content item, such as a 2D or 3D virtual object, indication of an application, message, image, etc. In various cases, the selection can be through a gesture, such as an air tap or grabbing the object, a user directing her gaze at the content item for a threshold amount of time, a voice command indicating an object, etc.

At block 1304, process 1300 can determine whether the selection performed at block 1302 designated a destination (e.g., after grabbing the content item dropping it on an entity associated with a destination or a voice command indicating an intention to share a selected content item to a destination) versus a selection that made a selection only (e.g., an air tap on an object, a gaze selection, pointing a ray at a content item). If the selection performed was for a selection only, process 1300 can continue to block 1312. If the selection performed was not for a selection only and indicated a destination, process 1300 can continue to block 1306.

At block 1306, process 1300 can identify a sharing destination based on the selection indicated at block 1302. For example, the selection indicated at block 1302 can indicate a destination by the user grabbing the content item dropping it on an entity associated with a destination or with a voice command indicating a destination.

At block 1308, process 1300 can determine whether the selection at block 1302 was by a voice command specifying to share a content item or was a grab and drop selection of the content item. If the selection at block 1302 was by a voice command (indicating a sharing action and a destination), process 1300 can continue to block 1316. If the selection at block 1302 was by a drag and drop gesture (indicating a destination but not necessarily that the destination is to be used for sharing the selected content item), process 1300 can continue to block 1310.

At block 1310, process 1300 can present an object options UI for the content item selected at block 1302, such as the UI 1004, and can receive a sharing selection, e.g., using control 1006. It should be noted that other selections from this UI are possible, but which take the user outside process 1300. From block 1310, process 1300 can proceed to block 1316.

Similarly from block 1304, at block 1312, process 1300 can present an object options UI for the content item selected at block 1302, such as the UI 1004, and can receive a sharing selection, e.g., using control 1006. From block 1312, process 1300 can proceed to block 1314. At block 1314, process 1300 can identify a sharing destination by providing a UI for the user to select a destination (such as UI 1110 of FIG. 11).

While any block can be removed or rearranged in various implementations, block 1316 is shown in dashed lines to indicate there are specific instances where block 1316 is skipped. At block 1316, process 1300 can receive a user's message to be provided with a shared content item. In some implementations, process 1316 is only performed when the selected sharing destination is a person or place. In some implementations, process 1300 can also provide one or more sharing preview or confirmation messages before sharing the selected content item to the selected destination. At block 1318, process 1300 can send the selected content item to the selected destination.

An XR system monitors a user in the XR environment, determines what activity the user is currently engaged in, and automatically (subject to constraints imposed by the XR system or by the user) sets a user status, which can be shared with others through representations in their artificial reality environment, via a status update to the user's social-media page, in live updates (e.g., on a contact for the user), etc.

The XR system monitors the user by means of any information available to it. This can include, in some variations, the time of day, a feed from a camera in the user's head-mounted display (HMD), a schedule of activities made by the user, sound from a microphone, information from an inertial monitoring unit (IMU) worn by the user, the user's location in the real world, and with what and whom the user interacts. The interactions can include the user's interactions with virtual objects in the XR environment.

The XR system analyzes the monitored information and attempts to determine what activity the user is currently engaged in. In some cases, this can include determining that the user is within a threshold distance of a pre-defined location or of a virtual object which the user has mapped to a particular status. In some variations, determining the user's activity can be as simple as reading the user's schedule and noting that it has him currently in a dentist appointment. In some variations, the determining may involve noting that the user has been in his kitchen for more than a threshold amount of time and has opened a recipe virtual object. From this, the XR can determine that the user is preparing a meal.

Having determined the user's current activity, the XR system can automatically update a status for the user. In some cases, this status is shown in relation to the user, such as on an avatar representing that user in others' artificial reality environments or in a contact representing the user. In some implementations, the status can be implemented for the user on a social media platform, such as by setting the user's live status or by creating a post for the user's activity as a status update to the user's social network. The post may be general or may be made visible to only a subset of the user's online friends, for example, those with an interest in cooking.

In some variations, for privacy and safety the user can create a profile that helps the XR system determine his activities. The profile can also set limits on what the XR system automatically posts. For example, the profile can state that the XR system can be told to post “busy” whenever the user is driving or at work.

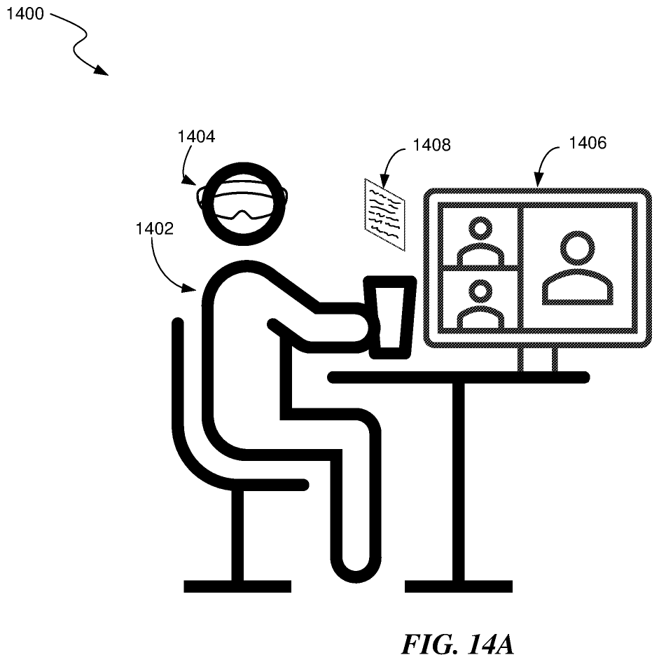

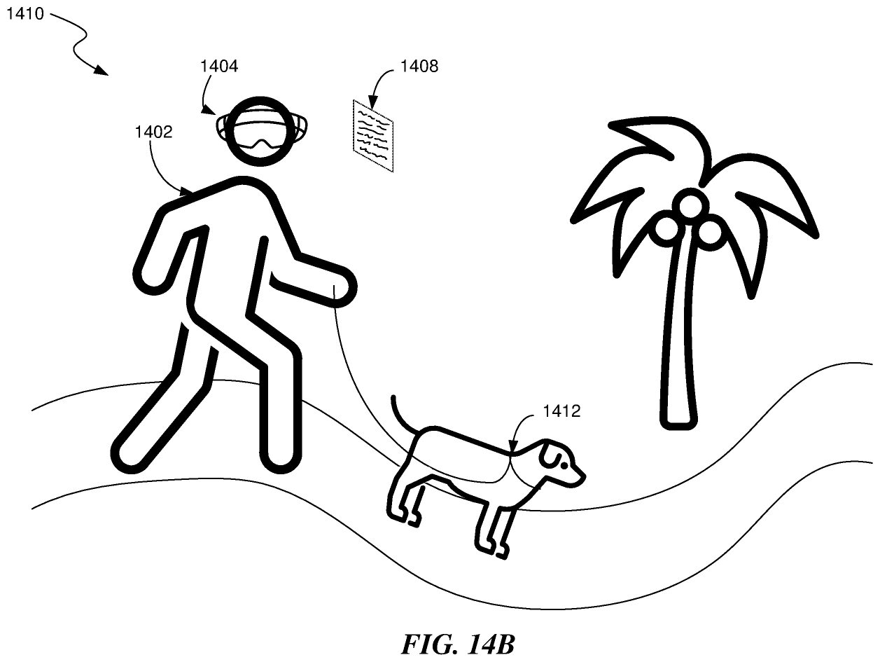

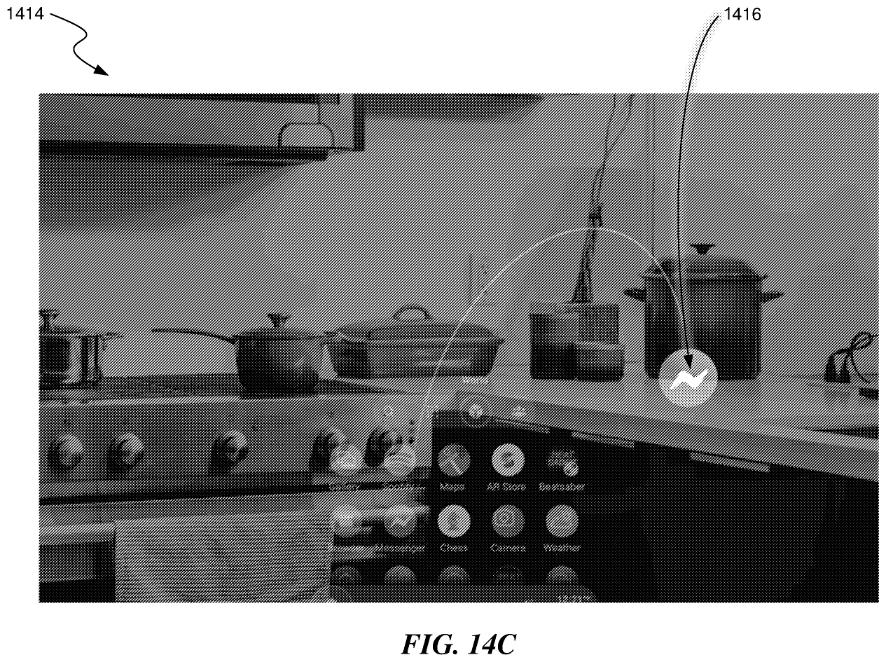

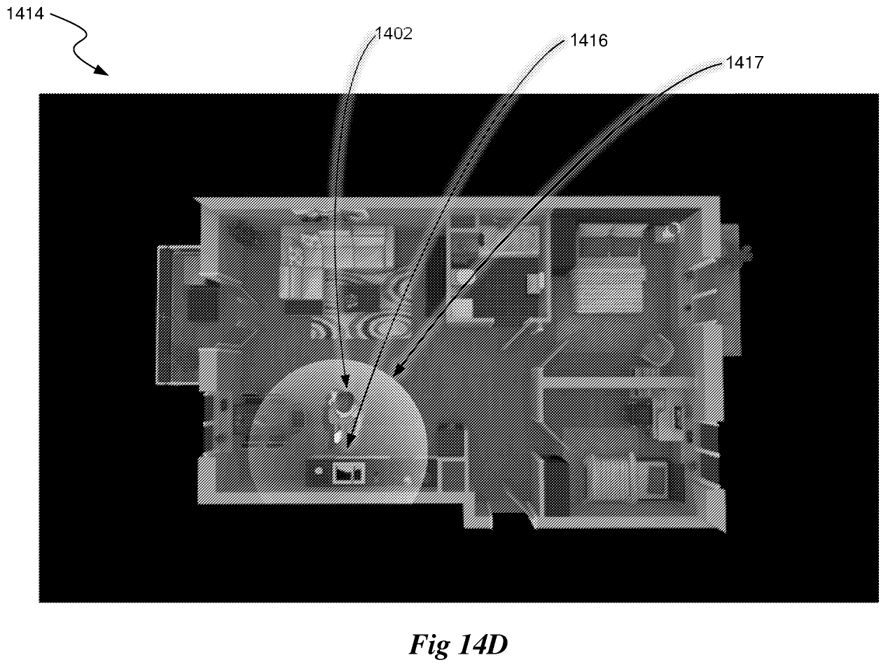

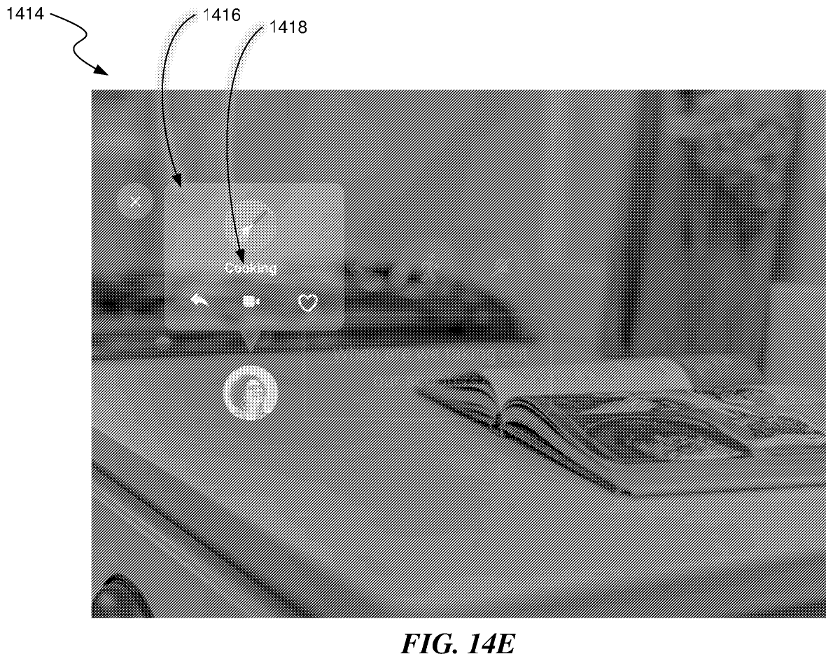

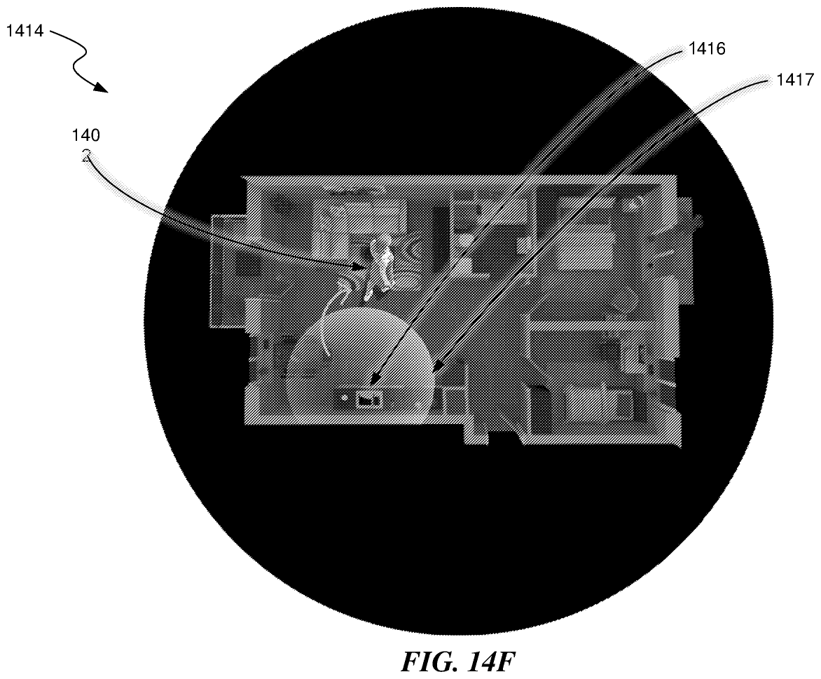

FIG. 14A is an example 1400 of a user 1402 engaged in a work activity. She is wearing an HMD 1404 that gives her access to the XR environment. Through the viewscreen of her HMD 1404, she sees a work-related display 1406. Because of the time of day, the user's location in her home office, and in reference to a schedule she has set, the XR system determines that the user is working. The XR system may automatically update her status on her social-media page 1408 to “working,” or, based on her profile, “bus ” y.

FIG. 14B is an example 1410 of the same user 1402 wearing her HMD 1404 while engaged in a leisure activity with her real dog 1412. In some variations, the XR system receives information from an IMU worn by the user 1402 and interprets that information as indicative of walking. The XR system also receives a feed from the HMD's cameras. An artificial-intelligence (Al) program analyzes this information, recognizes her dog 1412, and helps the XR system to determine that she is out walking her dog 1412. The XR system posts “walking the dog” to her social-media page 1408. In some variations, this user 1402 is concerned with distant acquaintances on her social network knowing when she has left her house. Thus for safety and privacy reasons, her profile tells the XR system to post “walking the dog” only to her closest friends, maybe even only to those closest friends who also own dogs, and posts “busy” to her more distant acquaintances.

In the extended scenario 1414 of FIGS. 14C through 14F, the user 1402 associates a specific status indication with a specific location. In FIG. 14C, she creates a virtual object 1416 and locks its location to the countertop next to the stove in her kitchen. As part of setting up the virtual object 1416, she sets criteria for a proximity range and for a duration threshold that, when met, trigger an automatic status update.

The overhead view of FIG. 14D shows the user 1402 in her kitchen. She is within the proximity range (shown as the area 1417) set for the virtual object 1416 set up in FIG. 14C. She has been in the proximity range 1417 of the virtual object 1416 for at least the set threshold duration. This last is to prevent spurious status updates every time she passes through the kitchen.

FIG. 14E shows the status update “Cooking” automatically set by the virtual object 1416 once the user's presence in her kitchen meets the proximity and duration criteria. This status update can be promulgated in any or all of several ways. In some cases, the “Cooking” status is shown in relation to the user's avatar in artificial reality environments or in a contact representing the user 1402. In some implementations, the status can be implemented for the user 1402 on a social media platform, such as by setting the user's live status or by creating a post for the user's activity as a status update to the user's social network.

FIG. 14F shows the user 1402 leaving the proximity 1417 of the virtual object 1416. Once she has been beyond the proximity range 1417 for at least a threshold duration, the “Cooking” status is no longer appropriate. The system either detects her new status (e.g., “Eating”) or reverts to a default status (e.g., “Busy”) as set in the user's profile and, in any case, sets the new status.

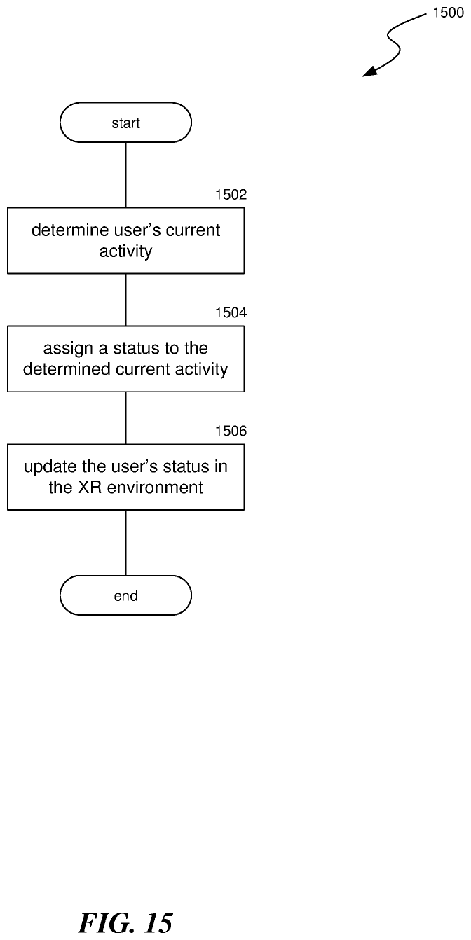

FIG. 15 is a flow diagram illustrating a process 1500 used in some implementations for automatically detecting a status change in a user's activity and setting a corresponding status. In some implementations, process 1500 constantly runs as long as the user is in the XR environment, as indicated by, for example, powering on the HMD 1404. Process 1500 may also run in accordance with the user's profile. For example, the profile can tell process 1500 to post “busy” (see block 1506) during the user's regular work hours. Then process 1500 only performs blocks 1502 and 1504 outside of those hours. In some variations, process 1500 is run entirely or in part on the user's local XR system. In some variations, process 1500 can access services running on remote servers, such as natural-language processors to decode speech or an Al to determine what is seen in a camera feed.

At block 1502, process 1500 can determine a user's current activity. There are many variations on this, limited only by the information available to process 1500.

In some variations, the user has previously associated a physical location (or a location of a virtual object she has added to her artificial reality environment) with a particular activity. When process 1500 determines that the user is in close proximity to that location for more than a threshold amount of time, process 1500 reads from the user's profile the activity previously associated with that location. For example, the user's presence in his kitchen can be associated with preparing a meal.

In a similar manner, the user's interaction with a specific virtual object may tell process 1500 that the user is engaged in a particular activity. If the user interacts with a virtual object for an online chess game, then process 1500 determines from that interaction what the user's current activity is. In some variations, the user need not have associated this virtual object with its activity. Instead, process 1500 can know the functions of the virtual object and determine the user's activity from that.

As in the scenario 1400 of FIG. 14A, process 1500 can in some variations determine the user's activity from his physical location, the time of day, and the user's normal daily schedule. Also or instead of the above, process 1500 can make its determination based on the user's interaction with a work-related virtual object or other application.

More generally, as in the scenario 1410 of FIG. 14B, process 1500 can access feeds from whatever devices are associated with the user (e.g., visual and audio feeds from the HMD 1402, the IMU, activity of the user's cellphone, and the like). Process 1500 can analyze all of this information (which may include sending queries to remote servers) to make an activity determination.

Information from devices outside the XR environment can be used. If the user is sitting on the couch and the television is on, process 1500 determines the user's activity as “watching television” or, more specifically from process 1500′s viewing of the television screen, “watching ‘Saving Private Ryan.’” But if the user is in the same location and the television is off, process 1500 may see that the user is “reading a book.”

If historical information about the user's activities is available to process 1500, then process 1500 can use that to inform its decision making. For example, without historical information, process 1500 might decide that the user's current status is “singing.” With the historical information that the user is a professional singer, process 1500 may refine that status to either “practicing” or “performing.”

Process 1500 can also ask the user what activity he is currently engaged in. If the user responds with an activity that is unfamiliar to process 1500, or responds with an activity that is not addressed in the user's profile, then process 1500 can ask whether the user wishes process 1500 to post a social-media status update and, if so, what status to post.

In all of the above examples, process 1500 can make intelligent assessments even if there is no user profile to consult. For example, process 1500 can refrain from posting a new status until the user is determined to have engaged in a new activity for more than a threshold amount of time, at more than a threshold activity level, etc. For example, process 1500 should not make the determination that the user is preparing a meal every time the user simply walks through the kitchen.

At block 1504, process 1500 can assign a status to the determined activity. In some variations, the assigned status is simply a short description of the activity as determined by process 1500 such as “working” or “walking the dog.”

In some variations, process 1500, either on its own initiative or as informed by the user's profile or historical information, may assign a status for the determined activity at a higher level in an “activity hierarchy.” For example, if the determined activity is “working,” the assigned status may be “busy” or “do not disturb.” If the determined activity is “reading a book,” then the assigned status may be “relaxing” or “available to talk.” When the process 1500 assigned a status high in the hierarchy, newly determined activities are more likely to fall into the same hierarchical status and not trigger a status change. If the user, for example, simply wants “at leisure” to be the assigned status, the user's change from one leisure activity to another might not change the status.

In some variations, process 1500 may determine that the user is engaged in overlapping activities such as cooking while talking on the telephone. Again, profile information or history may help process 1500 know which to choose as the more appropriate status. Process 1500 can also ask the user to confirm its choice of status in this situation and allow the user to confirm or to change that choice, possibly by selecting just one of the overlapping activities as the status to set. Process 1500, in some variations, may post multiple, simultaneous statuses for the user if the user allows that.

At block 1506, process 1500 can automatically set the user's status. As discussed in relation to FIG. 14E, the status can be used in one or more ways. For example, the new status can be set as the user's live status on the user's social-media page or can be sent in a post for the user's activity as a status update to the user's social network. In some cases, the updated status can be shown in relation to the user's avatar in artificial reality environments or in a contact representing the user 1402. As discussed above, the user's profile may prevent the posting for certain activities. Also as discussed above, the status update may be posted to be seen by only a subset of the user's online friends.

The information available to process 1500 that triggers a new activity determination in block 1502 can also be available to trigger the end of that activity. For example, if the user leaves a specified location (kitchen), stops interacting with a virtual object, or starts a second activity incompatible with the first, then process 1500 detects the change and determines the new activity by returning to block 1502.

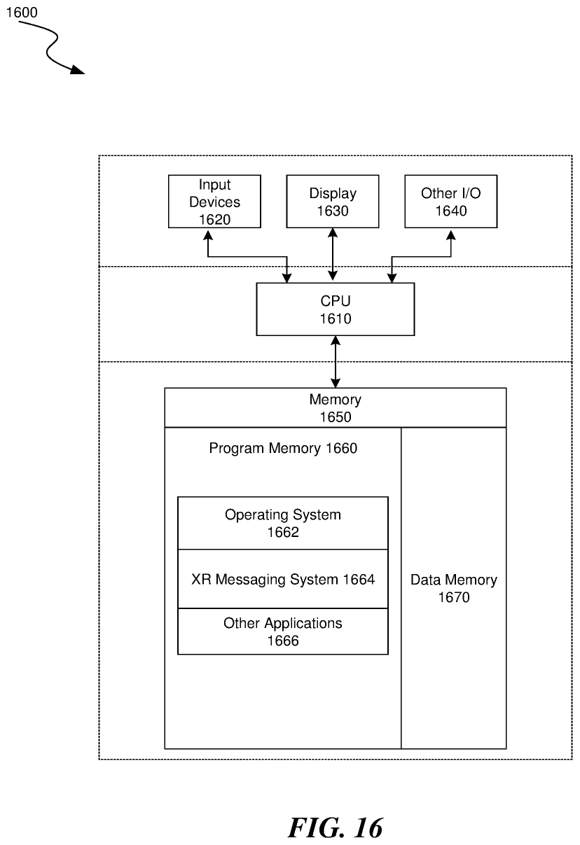

FIG. 16 is a block diagram illustrating an overview of devices on which some implementations of the disclosed technology can operate. The devices can comprise hardware components of a device 1600 that can deliver messages when a specified recipient context is detected, display artificial reality gesture effects in response to particular gesture triggers tied to those XR gesture effects, define actions of an artificial reality content sharing system for sharing content to user-selectable destinations, and automatically update a user's status in an artificial reality social-networking setting. Device 1600 can include one or more input devices 1620 that provide input to the Processor(s) 1610 (e.g., CPU(s), GPU(s), HPU(s), etc.), notifying it of actions. The actions can be mediated by a hardware controller that interprets the signals received from the input device and communicates the information to the processors 1610 using a communication protocol. Input devices 1620 include, for example, a mouse, a keyboard, a touchscreen, an infrared sensor, a touchpad, a wearable input device, a camera- or image-based input device, a microphone, or other user input devices.

Processors 1610 can be a single processing unit or multiple processing units in a device or distributed across multiple devices. Processors 1610 can be coupled to other hardware devices, for example, with the use of a bus, such as a PCI bus or SCSI bus. The processors 1610 can communicate with a hardware controller for devices, such as for a display 1630. Display 1630 can be used to display text and graphics. In some implementations, display 1630 provides graphical and textual visual feedback to a user. In some implementations, display 1630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1640 can also be coupled to the processor, such as a network card, video card, audio card, USB, firewire or other external device, camera, printer, speakers, CD-ROM drive, DVD drive, disk drive, or Blu-Ray device.

In some implementations, the device 1600 also includes a communication device capable of communicating wirelessly or wire-based with a network node. The communication device can communicate with another device or a server through a network using, for example, TCP/IP protocols. Device 1600 can utilize the communication device to distribute operations across multiple network devices.

The processors 1610 can have access to a memory 1650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1650 can include program memory 1660 that stores programs and software, such as an operating system 1662, communication and sharing system 1664, and other application programs 1666. Memory 1650 can also include data memory 1670 which can be provided to the program memory 1660 or any element of the device 1600.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

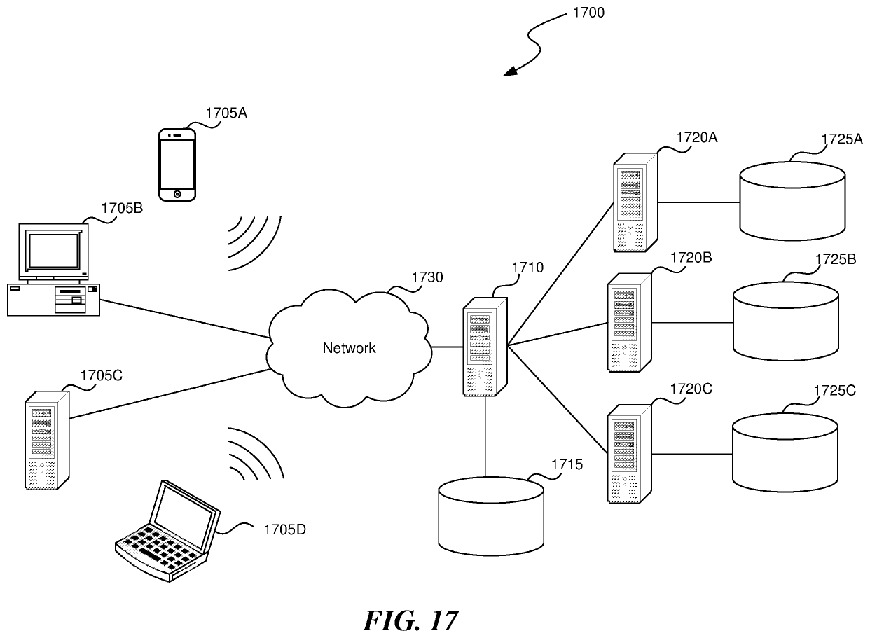

FIG. 17 is a block diagram illustrating an overview of an environment 1700 in which some implementations of the disclosed technology can operate. Environment 1700 can include one or more client computing devices 1705A-D, examples of which can include device 1600. Client computing devices 1705 can operate in a networked environment using logical connections through network 1730 to one or more remote computers, such as a server computing device.

In some implementations, server 1710 can be an edge server which receives client requests and coordinates fulfillment of those requests through other servers, such as servers 1720A-C. Server computing devices 1710 and 1720 can comprise computing systems, such as device 1600. Though each server computing device 1710 and 1720 is displayed logically as a single server, server computing devices can each be a distributed computing environment encompassing multiple computing devices located at the same or at geographically disparate physical locations. In some implementations, each server 1720 corresponds to a group of servers.

Client computing devices 1705 and server computing devices 1710 and 1720 can each act as a server or client to other server/client devices. Server 1710 can connect to a database 1715. Servers 1720A-C can each connect to a corresponding database 1725A-C. As discussed above, each server 1720 can correspond to a group of servers, and each of these servers can share a database or can have their own database. Databases 1715 and 1725 can warehouse (e.g., store) information. Though databases 1715 and 1725 are displayed logically as single units, databases 1715 and 1725 can each be a distributed computing environment encompassing multiple computing devices, can be located within their corresponding server, or can be located at the same or at geographically disparate physical locations.

Network 1730 can be a local area network (LAN) or a wide area network (WAN), but can also be other wired or wireless networks. Network 1730 may be the Internet or some other public or private network. Client computing devices 1705 can be connected to network 1730 through a network interface, such as by wired or wireless communication. While the connections between server 1710 and servers 1720 are shown as separate connections, these connections can be any kind of local, wide area, wired, or wireless network, including network 1730 or a separate public or private network.

In some implementations, servers 1710 and 1720 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, a method for automatically updating a status of a user in an XR environment, the method comprising: determining an activity currently engaged in by the user wherein the determining is based on one or more of: a proximity to a virtual object, an interaction with a virtual object, analyzing the user's context in the XR environment, a history of the user's context in the XR environment, or any combination thereof; assigning a status to the determined activity wherein the assigning is based on one or more of: categorization of the determined activity, a profile setting, or any combination thereof; and updating the user's status in the XR environment to the assigned status.

I/We claim:

1. A method for delivering messages when a specified recipient context is detected, the method comprising:
receiving a message, for at least one recipient, with an associated context expression;
receiving context conditions for the at least one recipient;
evaluating the context expression based on the context conditions and determining that the context expression is satisfied; and
in response, delivering the message to the at least one recipient.

2. A method for displaying an XR effect in response to a particular gesture trigger, the method comprising:
receiving an XR effect with a defined triggering gesture;
providing a notification of what gesture is needed to trigger the XR effect;
monitoring positions of one or more user body parts;
determining that the monitored positions match the gesture needed to trigger the XR effect and, in response:
activating the XR effect.

3. A method for providing interfaces and interaction modalities for sharing a content item to a user-selected destination, the method comprising:
receiving a selection of a sharable content item;
where the selection designates a destination, identifying the destination;
where the selection does not designate a destination,
providing a first UI to identify a sharing action; and
providing a second UI to identify the destination; and
sharing the selected content item to the selected destination.
